(19) United States
(12) Patent Application Publication
(10) Pub. No.: US 2015/0158986 A1
(43) Pub. Date: Jun. 11, 2015

(54) POLYMERIC INTERLAYER SHEETS AND LIGHT WEIGHT LAMINATES PRODUCED THEREFROM

(71) Applicant: E.I. DU PONT DE NEMOURS AND COMPANY, Wilmington, DE (US)

(72) Inventors: Jingjing XU, Wilmington, DE (US); Stephen J. BENNISON, Wilmington, DE (US); Steven C. PESEK, Orange, TX (US); Toshikazu KOBAYASHI, Aichi (JP); W. Alexander SHAFFER, Orange, TX (US); Shannon D. MEERSCHEIDT, Bridge City, TX (US); Charles Anthony SMITH, Vienna, WV (US); Sam Louis SAMUELS, Landenberg, PA (US); Steven M. HANSEN, Wilmington, DE (US); Yuki SHITANOKI, Utsunomiya (JP); Kazuyuki NAKATA, Ichihara City (JP)

(21) Appl. No.: 14/560,624

(22) Filed: Dec. 4, 2014

Related U.S. Application Data
(60) Provisional application No. 61/912,904, filed on Dec. 6, 2013.
(60) Provisional application No. 61/992,026, filed on May 12, 2014.

(51) Int. Cl. C08J 5/18; B32B 27/36; B32B 27/34; B32B 27/40; B32B 23/20; B32B 18/00; B32B 27/38; B32B 27/06; B32B 17/10; B32B 15/085; B32B 15/082; B32B 27/30; B32B 27/32

(52) U.S. Cl. CPC C08J 5/18; B32B 27/308; B32B 27/36; B32B 27/365; B32B 27/302; B32B 27/34; B32B 27/40; B32B 23/20; B32B 27/32; B32B 27/322; B32B 27/38; B32B 27/06; B32B 17/10743; B32B 15/085; B32B 15/082; B32B 18/00; C08J 2323/08; B32B 2250/02; B32B 2250/03; B32B 2250/04; B32B 2255/26; B32B 2307/10; B32B 2315/08; B32B 2315/02; B32B 2323/04; B32B 2325/00; B32B 2327/06; B32B 2333/04; B32B 2363/00; B32B 2367/00; B32B 2369/00; B32B 2375/00; B32B 2377/00

(57) ABSTRACT

Provided herein are interlayer sheets formed of an acid copolymer composition, which comprises an acid copolymer resin or an ionomer that is the neutralized product of the acid copolymer resin. The acid copolymer resin comprises copolymerized units of an α-olefin having 2 to 10 carbon atoms; about 10 to about 25 wt % of copolymerized units of a first α,β-ethylenically unsaturated carboxylic acid having 3 to 10 carbon atoms; and about 15 to about 30 wt % of copolymerized units of a derivative of a second α,β-ethylenically unsaturated carboxylic acid having 3 to 10 carbon atoms. In addition, the acid copolymer resin has a melt flow rate of about 1 to about 400 g/10 min. Light weight safety laminates comprising these interlayer sheets are characterized by good strength and superior acoustic damping, due to the properties of the acid copolymer composition.

### CROSS-REFERENCES TO RELATED APPLICATIONS

The present application claims priority under 35 U.S.C. §119 to U.S. Provisional Appln. Nos. 61/912,904, filed on Dec. 6, 2013, and 61/992,026, filed on May 12, 2014, each of which is incorporated herein by reference in its entirety.

### FIELD OF THE INVENTION

Provided herein are interlayer sheets formed of an acid copolymer composition. In particular, light weight safety laminates comprising these interlayer sheets are characterized by good strength and superior acoustic damping, due to the properties of the acid copolymer composition.

### BACKGROUND OF THE INVENTION

Several patents and publications are cited in this description in order to more fully describe the state of the art to which this invention pertains. The entire disclosure of each of these patents and publications is incorporated by reference herein.

Laminated structures that include a polymeric interlayer are useful in the construction of a variety of buildings and vehicles. They may provide important properties such as mechanical strength, safety characteristics including puncture resistance, and acoustic damping. One important subset of laminated structures, safety glass laminates, has been in commercial production for almost a century and has been utilized in applications that require sheet material having a high degree of clarity and impact resistance. For example, safety glass laminates have been widely used in the automobile industry as windshields and side windows because the laminate structures are characterized by high impact and penetration resistance and because they do not scatter glass shards and debris when shattered. More recently, safety glass laminates have also been incorporated into building structures as windows, interior building partitions, stairs, roof glazing and backlites, building façades, and the like.

Simple safety glass laminates typically consist of a sandwich of two glass sheets or panels bonded together with an interlayer that is a polymeric sheet. One or both of the glass sheets may be replaced with optically clear rigid polymeric sheets, such as sheets made of polycarbonate. Safety glass laminates have further evolved to include multiple layers of glass or rigid polymeric sheets bonded together with polymeric interlayers. Examples of these more complicated constructions are described in U.S. Pat. No. 7,641,965, issued to Bennison et al.

The interlayers used in safety glazing laminates are typically made from relatively thick polymer sheets, which exhibit toughness and bondability to the glass in the event of a crack or crash. Widely used interlayer materials include complex, multicomponent compositions based on poly(vinyl butyral), poly(urethane), and ethylene vinyl acetate copolymers.

Ionomers are copolymers produced by partially or fully neutralizing the carboxylic acid groups of precursor or “parent” copolymers that are acid copolymers comprising copolymerized residues of α-olefins and α,β-ethylenically unsaturated carboxylic acids. The use of ionomer interlayer sheets in safety laminates is known. See, for example, U.S. Pat. Nos. 3,344,014; 3,762,988; 4,663,228; 4,668,574; 4,799,346; 5,759,698; 5,763,062; 5,895,721; 6,150,028; 6,265,054; and 6,432,522, U.S. Patent Appln. Publn. Nos. 20020155302; 20060182983; 20070092706; 20070122633; 20070289693; 20080044666, and PCT Patent Appln. Publn. Nos. WO9958334; WO2006057771; and WO2007149082.

In this connection, ionomers have been useful in safety laminates intended for structures requiring a high degree of penetration resistance. Some examples include hurricane-resistant glazing and structural elements such as glass staircases and glass balustrades. In a particularly demanding application, the use of ionomeric interlayer sheets in safety laminates having ballistic resistance is described in U.S. Pat. Nos. 5,002,820 and 7,641,965 and PCT Patent Appln. Publn. No. WO03068501, for example.

It may be desirable to modify conventional laminates by reducing their weight. Light weight safety glazing is of great interest in the automotive industry, where reducing the mass of vehicles translates directly into improved fuel efficiency and lower carbon emissions. Simply reducing a laminate's weight, however, for example by reducing the thickness of each of its component layers, is likely to produce a laminate that lacks adequate strength to function as safety glazing. Moreover, laminates having lower weights are also characterized by increased noise transmission. This property is undesirable in glazing and other laminates, whether intended for transportation or for architectural end uses.

Moreover, in certain uses, safety characteristics are optional and acoustic dampening properties are desirable. Examples include, without limitation, laminates for building façades, exterior walls and roofs; panels, doors, walls and other interior partitions; architectural structures and transportation vehicles. Laminates designed for these end uses need not be optically transparent and may include rigid sheets made from opaque or translucent materials such as metal, ceramic, stone, pigmented polymers or pigmented glass. In addition or in the alternative, these laminates may also include opaque or translucent interlayers.

Accordingly, there is a need to develop an ionomer composition that is useful as an interlayer in light weight laminates so that the laminates retain good strength and good acoustical barrier properties in safety glazing and other end uses.

### SUMMARY OF THE INVENTION

Provided herein is a polymeric interlayer sheet that includes an acid copolymer composition, which composition in turn includes an acid copolymer resin or an ionomer that is the neutralized product of the acid copolymer resin. The acid copolymer resin comprises copolymerized units of an α-olefin having 2 to 10 carbon atoms; about 10 to about 25 wt % of copolymerized units of a first α,β-ethylenically unsaturated carboxylic acid having 2 to 10 carbon atoms; and about 10 to about 40 wt % of copolymerized units of a derivative of a second α,β-ethylenically unsaturated carboxylic acid having 2 to 10 carbon atoms. The first and the second α,β-ethylenically unsaturated carboxylic acids may be the same or different; the sum of the weight percentages of the copolymerized units in the acid copolymer resin is 100 wt % and the weight percentages are based on the total weight of the acid copolymer resin; and the acid copolymer resin has a melt flow rate of up to about 4000 g/10 min, as determined in accordance with ASTM D1238 at 190° C. and 2.16 kg. Further provided are laminates, for example safety laminates and safety glass laminates, that include the polymeric interlayer sheets described herein.

### DETAILED DESCRIPTION OF THE INVENTION

The following definitions apply to the terms as used throughout this specification, unless otherwise limited in specific instances.

The technical and scientific terms used herein have the meanings that are commonly understood by one of ordinary skill in the art to which this invention belongs. In case of conflict, the present specification, including the definitions herein, will control.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format. Optional additives as defined herein, at a level that is appropriate for such additives, and minor impurities are not excluded from a composition by the term “consisting essentially of”.

In this connection, the acoustic damping properties of the interlayer; one or more of the physical properties associated with acoustic damping, such as tan δ or shear modulus; and one or more of the physical properties associated with safety laminates, such as strength, adhesion and penetration resistance, are considered basic and novel characteristics of the invention.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Unless stated otherwise, all percentages, parts, ratios, and like amounts, are defined by weight.

Unless otherwise specified under limited circumstances, all melt flow rates are measured according to ASTM method D1238 at a polymer melt temperature of 190° C. and under a weight of 2.16 kg. Moreover, the terms melt flow rate (MFR), melt flow index (MFI) and melt index (MI) are synonymous and used interchangeably herein.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

The term “acid copolymer” as used herein refers to a polymer comprising copolymerized units of an α-olefin, an α,β-ethylenically unsaturated carboxylic acid, and optionally other suitable comonomer(s) such as, an α,β-ethylenically unsaturated carboxylic acid ester.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “ionomer” as used herein refers to a polymer that comprises ionic groups that are carboxylate salts, for example, ammonium carboxylates, alkali metal carboxylates, alkaline earth carboxylates, transition metal carboxylates and/or combinations of such carboxylates. Such polymers are generally produced by partially or fully neutralizing the carboxylic acid groups of precursor or parent polymers that are acid copolymers, as defined herein, for example by reaction with a base. An example of an alkali metal ionomer as used herein is a sodium ionomer (or sodium neutralized mixed ionomer), for example a copolymer of ethylene and methacrylic acid wherein all or a portion of the carboxylic acid groups of the copolymerized methacrylic acid units are in the form of sodium carboxylate groups.

The term “laminate”, as used herein alone or in combined form, such as “laminated”, refers to a structure in which at least two layers are adhered or bonded either directly (i.e., without any additional material between the two layers) or indirectly (i.e., with additional material, such as interlayer or adhesive materials, between the two layers).

Finally, the term “safety laminate” refers to a laminated structure that has physical characteristics including one or more of puncture resistance and good adhesion between the polymeric interlayer and the outer layers. The terms “safety glazing” and “safety glass laminate” are synonymous and used interchangeably herein to refer to a subset of “safety laminates” in which the outer layers are glass. Safety glazing may be optically transparent, translucent or opaque.

Provided herein is a polymeric interlayer sheet that includes an acid copolymer composition, which composition in turn includes an acid copolymer resin or an ionomer that is the neutralized product of the acid copolymer resin.

Suitable acid copolymer resins comprise copolymerized units of an α-olefin having 2 to 10 carbon atoms; copolymerized units of a first α,β-ethylenically unsaturated carboxylic acid having 3 to 10 carbon atoms; and copolymerized units of a derivative of a second α,β-ethylenically unsaturated carboxylic acid having 3 to 10 carbon atoms.

Suitable α-olefin comonomers include, but are not limited to, ethylene, propylene, 1-butene, 1-pentene, 1-hexene, 1-heptene, 3 methyl-1-butene, 4-methyl-1-pentene, and the like, and combinations of two or more of these α-olefins. In some preferred embodiments, the α-olefin is ethylene.

Preferably, the first and the second α,β-ethylenically unsaturated carboxylic acids have from 3 to 8 carbon atoms. They may suitably be selected from, without limitation, acrylic acids, methacrylic acids, itaconic acids, maleic acids, maleic anhydrides, fumaric acids, and combinations of two or more of these acid comonomers. In some preferred embodiments, the first and the second α,β-ethylenically unsaturated carboxylic acid are selected from acrylic acids, methacrylic acids, and combinations of two or more (meth)acrylic acids. Acrylic acid and methacrylic acid are more preferred. In addition, the first and the second α,β-ethylenically unsaturated carboxylic acids may be the same or different.

Suitable derivatives of the second α,β-ethylenically unsaturated carboxylic acid include acid anhydrides, amides, and esters, for example monomethyl maleic acid esters. Some suitable acid copolymer resins comprise an ester of the second α,β-ethylenically unsaturated carboxylic acid. Examples of suitable esters of α,β-ethylenically unsaturated carboxylic acids include, but are not limited to, those that are set forth in U.S. Pat. No. 8,399,096, issued to Hausmann et al. Preferred are alkyl esters in which the alkyl groups include from 1 to 6 carbon atoms. Examples of preferred derivatives of the second α,β-ethylenically unsaturated carboxylic acid include, but are not limited to, methyl(meth)acrylates, butyl(meth)acrylates, such as n-butyl(meth)acrylate and i-butyl(meth)acrylate, and combinations of two or more of these derivatives. n-Butyl acrylate, i-butyl acrylate and combinations of these two alkyl acrylates are more preferred derivatives of the second α,β-ethylenically unsaturated carboxylic acid.

The acid copolymer resin may further comprise copolymerized units of other comonomer(s). The other comonomers described in U.S. Pat. No. 8,399,096 (cited above) as suitable for inclusion in the precursor acid copolymers are also suitable for inclusion in the acid copolymer resins described herein. Preferred other comonomers include glycidyl methacrylates, vinyl acetates, carbon monoxide, norbornene, alkyl vinyl ethers, and other comonomers that provide additional benefits in properties or functionality, such as enhanced adhesion or ability to crosslink. In certain embodiments, however, it is preferred that the acid copolymer not include copolymerized units of other comonomer(s).

Preferably, the acid copolymer resin comprises at least about 9 wt %, or about 10 wt %, or about 12 wt %, or about 15 wt %, or about 17 wt %, or about 20 wt % of copolymerized units of the first α,β-ethylenically unsaturated carboxylic acid, and up to about 21 wt %, or about 22 wt %, or about 23 wt %, or about 24 wt %, or about 25 wt %, or about 27 wt %, or about 30 wt % of copolymerized units of the first α,β-ethylenically unsaturated carboxylic acid, based on the total weight of the acid copolymer resin. Also preferably, the acid copolymer resin comprises at least about 10 wt %, about 12 wt %, about 15 wt %, or about 17 wt %, or about 20 wt %, or about 23 wt %, or about 24 wt %, or about 25 wt % of the copolymerized units of the derivative of the second α,β-ethylenically unsaturated carboxylic acid and up to about 25 wt %, or about 26 wt %, or about 27 wt %, or about 28 wt %, or about 29 wt %, or about 30 wt %, or about 35 wt %, about 40 wt % of the copolymerized units of the derivative of the second α,β-ethylenically unsaturated carboxylic acid, based on the total weight of the acid copolymer resin. Copolymerized units of other comonomer(s), if present, are preferably included in an amount of about 0.001 to about 10 wt %, or about 0.01 to about 5 wt %, or about 0.1 to about 2 wt %, based on the total weight of the acid copolymer resin. More preferably, however, the acid copolymer resin does not incorporate other comonomers in any significant amount. The amount of copolymerized α-olefin is complementary to the amount of copolymerized carboxylic acid, carboxylic acid derivative and other comonomer(s), if present, so that the sum of the weight percentages of the comonomers in the acid copolymer resin is 100 wt %.

The acid copolymer resin may have a melt flow rate (MFR) of about 1 to about 4000 g/10 min, about 10 to about 2500 g/10 min, about 10 to about 1400 g/10 min, about 10 to about 1000 g/10 min, or about 10 to about 500 g/10 min, or about 20 to about 400 g/10 min, or about 20 to about 200 g/10 min, or about 20 to about 80 g/10 min, or up to about 100 g/10 min or up to about 200 g/10 min or up to about 300 g/10 min, as determined in accordance with ASTM method D1238 at 190° C. and 2.16 kg.

The precursor acid copolymers may be synthesized by methods that are described in detail in U.S. Pat. Nos. 3,404,134; 6,518,365; 8,399,096, and references cited therein. In one embodiment, a method described in U.S. Pat. No. 8,399,096 is used, and a sufficiently high level and complementary amount of the derivative of the second α,β-ethylenically unsaturated carboxylic acid is present in the reaction mixture.

To obtain the ionomers useful in the acid copolymer compositions described herein, the acid copolymer resins are neutralized with a base so that the carboxylic acid groups in the acid copolymer resin react to form carboxylate groups. Preferably, the carboxylic acid groups in the acid copolymer are neutralized to a level of about 1 to about 90%, or about 5% to about 80%, or about 10% to about 70%, or about 15% to about 60%, or about 20% to about 50%, or up to about 20%, or up to about 17%, or up to about 15%, based on the total carboxylic acid content of the precursor acid copolymers as calculated or measured for the non-neutralized precursor acid copolymers.

Any stable cation and any combination of two or more stable cations are believed to be suitable as counterions to the carboxylate groups in the ionomer. Divalent and monovalent cations, such as cations of alkali metals, alkaline earth metals, and some transition metals, are preferred. Zinc cations are preferred divalent ions, and sodium cations are preferred monovalent ions. In one embodiment, the base is a sodium ion-containing base, to provide a sodium ionomer wherein about 1% to about 50% or about 5% to about 30%, or about 10% to about 20% of the hydrogen atoms of the carboxylic acid groups of the precursor acid are replaced by sodium cations. In another embodiment, the base is a zinc ion-containing base, to provide a zinc ionomer wherein about 1% to about 50% or about 5% to about 30%, or about 10% to about 20% of the hydrogen atoms of the carboxylic acid groups of the precursor acid are replaced by a charge-equivalent quantity of zinc cations.

The resulting ionomer may have a MFR of about 250 g/10 min or less, or about 100 g/10 min or less, or about 50 g/10 min or less, or about 40 g/10 min or less, or of about 25 g/10 min or less, or about 0.7 to about 25 g/10 min or less, or about 0.7 to about 19 g/10 min or less, or about 1 to about 10 g/10 min, or about 1.5 to about 5 g/10 min, or about 2 to about 4 g/10 min, as determined in accordance with ASTM method D1238 at 190° C. and 2.16 kg.

The acid copolymer resins may be neutralized by any conventional procedure, such as those disclosed in U.S. Pat. Nos. 3,404,134 and 6,518,365, and by other procedures that will be apparent to those of ordinary skill in the art. Some of these methods are described in detail in U.S. Pat. No. 8,334,033, issued to Hausmann et al.

The acid copolymer composition may further comprise one or more other polymers, such as, for example, acid copolymer resins as described above, other ionomers as described above, poly(ethylene vinyl acetates), poly(vinyl acetals) (including acoustic grade poly(vinyl acetals)), polyurethanes, polyvinylchlorides, polyethylenes (e.g., linear low density polyethylenes), polyolefin block elastomers, poly(α-olefin-co-α,β-ethylenically unsaturated carboxylic acid ester)s (e.g., poly(ethylene-co-methyl acrylate) and poly(ethylene-co-butyl acrylate)), silicone elastomers, epoxy resins, and combinations of two or more of these polymers. In some embodiments, the other polymer is a second acid copolymer resin that is different from the acid copolymer resin described above, or a second ionomer that is different from the ionomer described above. The acid copolymer composition may comprise, based on its total weight, from 0.001 wt % or 0.01 wt % up to about 2 wt %, 5 wt %, 7.5 wt % or 10 wt % of the other polymer(s). In some embodiments, the acid copolymer composition does not incorporate other polymer(s) in any significant amount. Finally, the acid copolymer composition comprising the other polymer(s) may be prepared by any suitable blending process, such as melt blending, for example.

The acid copolymer composition described herein may further contain any suitable additive known in the art. Such additives include, but are not limited to, plasticizers, processing aides, flow enhancing additives, flow reducing additives (e.g., organic peroxides), lubricants, pigments and fillers, dyes, optical brighteners, flame retardants, impact modifiers, nucleating agents, antiblocking agents (e.g., silica), thermal stabilizers, hindered amine light stabilizers (HALS), colorants, UV absorbers, UV stabilizers, dispersants, surfactants, chelating agents, coupling agents, adhesives, primers, reinforcement additives (e.g., glass fiber), and the like, and mixtures or combinations of two or more of these additives.

These additives are described in the Kirk Othmer Encyclopedia of Chemical Technology, 5^{th} Edition, John Wiley & Sons (New Jersey, 2004), for example. These additives may be present in the acid copolymer compositions in quantities of about 0.01 wt % or 0.1 wt % up to about 2 wt %, 3 wt %, 4 wt %, 5 wt %, 10 wt % or 15 wt %, based on the total weight of the acid copolymer composition, so long as they do not detract from the basic and novel characteristics of the composition and do not significantly adversely affect the performance of the composition or of the articles prepared from the composition.

More specifically, colorants include materials that reduce yellowing (“bluing agents”), tint the laminate, and control solar light transmission. Solar light transmission may be controlled by including an inorganic or organic infrared absorbing material, such as indium tin oxide, antimony tin oxide, lanthanum hexaboride, cesium tungsten trioxide (CsₓWO₃), phthalocyanines and naphthalocyanines, for example. These materials are described in U.S. Pat. No. 7,622,192, issued to Fugiel et al.; and in U.S. Pat. No. 7,759,414, issued to Hayes et al., which also include specific information about preferred levels of infrared absorbing materials in transparent laminates and methods of compounding infrared absorbing materials into acid copolymer compositions.

Three notable additives are thermal stabilizers, UV absorbers, and hindered amine light stabilizers. These additives are described in detail in U.S. Pat. No. 8,334,033, cited above. A fourth notable additive is a silane coupling agent, which may be added to the acid copolymer composition to improve its adhesive strength. Examples of suitable silane coupling agents that are useful in the compositions described herein include, but are not limited to, dialkoxysilanes and γ-chloropropylmethoxysilane, vinyltrimethoxysilane, vinyltriethoxysilane, vinyltris(β-methoxyethoxy)silane, γ-vinylbenzyl-propyltrimethoxysilane, N-β-(N-vinylbenzylaminoethyl)-γ-aminopropyl-trimethoxy-silane, γ-methacryloxypropyl-trimethoxysilane, vinyltriacetoxy-silane, γ-glycidoxypropyl-trimethoxysilane, γ-glycidoxypropyl-triethoxysilane, β-(3,4-epoxycyclohexyl)-ethyltrimethoxysilane, vinyltrichlorosilane, γ-mercaptopropylmethoxysilane, γ-aminopropyltriethoxysilane, N-β-(aminoethyl)-γ-aminopropyltrimethoxysilane, and combinations of two or more thereof. The silane coupling agents may be incorporated in the acid copolymer composition at a level of about 0.01 to about 5 wt %, or about 0.05 to about 1 wt %, based on the total weight of the acid copolymer composition.

A fifth notable class of additives is pigments and fillers. When intended for use in light-transmitting laminates, the acid copolymer compositions may incorporate 10 wt % or less, preferably 5 wt % or less, or more preferably 1 wt % or less of pigments, based on the total weight of the layer composition. Light-transmitting laminates include transparent and translucent laminates. Translucent laminates, which have a high level of haze or a low level of clarity, are described in detail in U.S. Patent Appln. Publn. No. 2013/0225746 by Steven M. Hansen et al. Briefly, however, aluminum trihydroxide (Al(OH)₃) is a preferred pigment for translucent laminates, and particularly preferred for laminates of interlayers comprising acid copolymer resins and ionomers of acid copolymer resins. In transparent laminates, which are characterized by high clarity or low haze, the pigments and fillers are also preferably transparent, so that the laminate will have low haze. For example, the use of fillers having an index of refraction approximately equal to that of the polymeric interlayer will result in lower levels of haze. Most polymers have an index of refraction of about 1.50; fillers having an index of refraction in this range include, without limitation, glass flakes, glass fibers, silicas, clays, talcs, micas and calcium carbonates. In addition, nanoparticulate fillers have been used to produce transparent interlayers. See, for example, transparent nanofilled encapsulant materials described in Intl. Patent Appln. Publn. No. WO 2014/059204 by Sam L. Samuels et al.

When the laminate is not required to transmit light, however, pigments or fillers having any higher indices of refraction may be suitable. Non-limiting examples include titanium dioxide, barium sulfate and zinc oxide. In polymeric interlayer sheets designed for these end uses, the upper limit on the pigment of filler concentration is determined by the physical integrity of the acid copolymer composition. More specifically, as long as there is sufficient polymer present to adhere the pigment particles to each other and to the adjacent layers, the polymeric interlayer sheet may be suitable for use in an acoustic dampening laminate. In a safety laminate, a greater area of contact between the polymer and the adjacent layers may be necessary, and a lower concentration of pigment may be required to provide this property and to provide sufficient penetration resistance. In general, however, acid copolymer compositions for non-transparent end uses may include up to about 50 wt % of pigments and fillers.

A preferred method for forming pigment and filler concentrate compositions suitable for use as additives in the acid copolymer composition is described in U.S. Pat. No. 7,759,414.

The optional incorporation of these notable additives into the compositions can be carried out by any known process. This incorporation can be carried out, for example, by dry blending, by extruding a combination of the various constituents, by a masterbatch technique, or the like. See, again, the Kirk-Othmer Encyclopedia.

Finally, the acid copolymer compositions may further incorporate additives that effectively reduce the melt flow of the resin, to the limit of producing thermoset layers. The use of such additives will enhance the upper end use temperature of the multilayer polymeric laminate and the high strength laminate of the present invention. Typically, the end use temperature will be enhanced by an increase of 20° C. to 70° C. In addition, laminates produced from such materials will be less hazardous in a fire. Evidently, acid copolymer compositions that melt and flow out of the laminate may serve as additional fuel for a fire. When the upper end use temperature is increased, however, this hazardous tendency is reduced. Any known method for reducing the melt flow of the material can be used, including but not limited to peroxide cross linkage technology, electron beam technology, and epoxy cross linkage technology.

Further provided is a polymeric interlayer sheet, for use in safety laminates, that comprises the acid copolymer composition described herein. Laminates comprising or produced from the polymeric interlayer sheets described herein exhibit equal or better acoustic properties compared with laminates made from prior art compositions. The term “equal or better acoustic properties” as used herein refers to equal or lower sound transmission as determined in accordance with ISO Standard No. 16940 (2008).

In order to provide the acoustic properties described herein, the polymeric interlayer sheet or one or more of the “components” of the polymeric interlayer sheet is characterized by one or more of the following physical properties. First, tan δ, as measured according to ASTM Standard No. D4065-06 at 20° C. and 1 kHz, is more than 0.25, more than 0.30, more than 0.50, more than 0.75, more than 1.0, or more than 2.0. Second, the shear modulus as measured according to ASTM Standard No. D4092-07 at 20° C. and 1 kHz is less than 150 MPa, less than 100 MPa, less than 75 MPa, less than 50 Mpa, or less than 25 MPa. The term “component”, as used in this context, refers to the acid copolymer composition, the ethylene acid copolymer or its ionomer.

The polymeric interlayer sheet may have a single layer or multilayer form. The term “single layer”, as used in this context, refers to a sheet consisting of one monolithic layer that is made of or that consists essentially of the ethylene acid copolymer, its ionomer, or the acid copolymer composition described herein. Some preferred polymeric interlayer sheets are multilayer sheets, however. Multilayer construction enables greater flexibility in the choice of polymeric interlayer sheets, as the advantages and disadvantages of each material can be balanced by combination with other, complementary materials. For example, a layer of a material that has good acoustic properties and less than optimal penetration resistance can be combined with a layer of a complementary material having good tensile properties.

When in multilayer form, the polymeric interlayer sheet includes two or more sub-layers. At least one of these sub-layers comprises, is made from or consists essentially of the ethylene acid copolymer, its ionomer, or the acid copolymer composition described herein. The remaining sub-layer(s) may be made of any suitable polymeric material(s), such as, for example, an acid copolymer composition as described above, an acid copolymer resin as defined above, an ionomer as defined above, ethylene/vinyl acetate copolymers, poly(vinyl acetals) (including acoustic grade poly(vinyl acetals)), polyurethanes, polyvinylchlorides, polyethylenes (e.g., linear low density polyethylenes), polyolefin block elastomers, copolymers of α-olefins and α,β-ethylenically unsaturated carboxylic acid esters (e.g., ethylene methyl acrylate copolymers and ethylene butyl acrylate copolymers), silicone elastomers, epoxy resins, and combinations of two or more of these suitable polymeric materials. In addition, when two or more sublayers are present in the polymeric interlayer sheets, the sublayers may be formed of polymeric materials that are the same or different.

Examples of preferred multilayer sheets include, without limitation, a bilayer structure in which the second layer is a second acid copolymer or the ionomer of the second acid copolymer. The second acid copolymer and its ionomer may be the same as or different from the acid copolymer or ionomer in the first layer. Also preferred is a trilayer structure in which the inner layer comprises the ethylene acid copolymer, its ionomer, or the acid copolymer composition described herein. In this preferred trilayer structure, the outer layers comprise a copolymer of ethylene and vinyl acetate. Alternatively, the outer layers comprise a second acid copolymer or its ionomer that may be the same as or different from the acid copolymer or ionomer in the first layer.

More preferred is a trilayer structure in which the inner layer comprises the acid copolymer composition and the outer layers comprise an ionomer composition. The ionomer composition is described in detail in co-pending U.S. Provisional Appln. No. 61/856,820, by Bennison et al., filed on Jul. 22, 2013 (Attorney Docket No. PP0297 USPSP). Briefly, however, the ionomer composition includes an ionomer that is produced from a copolymer of an α-olefin and about 0.1 to about 30 weight percent of an α,β-ethylenically unsaturated carboxylic acid comonomer. The copolymer may also include from 0 to 50 wt % or from 0 to 40 wt % of copolymerized repeat units of one or more additional comonomers. The melt index of the copolymer is up to about 200 g/10 min, more preferably about 10 to about 100 g/10 min, and still more preferably about 20 to about 60 g/10 min. At least a portion of the carboxylate groups in the copolymer are neutralized to form the ionomer, in which the carboxylate salts may have any stable cation as a counterion. The melt index of the ionomer is preferably about 1 to about 50 g/10 min. Ethylene is a preferred α-olefin, acrylic acid and methacrylic acid are preferred α,β-unsaturated carboxylic acids; and preferred additional comonomers include glycidyl methacrylate, vinyl acetate, and alkyl esters of acrylic acid or methacrylic acid, in which the alkyl groups contain from 1 to 4 carbon atoms. Preferred cations include cations of alkali metals and alkaline earth metals.

Preferred ionomers for use in the outer layers of a trilayer structure consist essentially of from about 70 to about 79 or 80 wt % of copolymerized repeat units of ethylene and from about 20 or 21 to about 30 wt % of copolymerized repeat units of an α,β-unsaturated carboxylic acid having from 2 to 8 carbons, wherein at least about 20% to about 35% of the carboxylic acid groups are neutralized, the counterions of the carboxylate groups are sodium or zinc cations, and the resin has a melt index of about 60 g/10 minutes or less prior to neutralization. Also preferred are ionomers that consist essentially of from about 50 or 55 to about 74 wt % of copolymerized repeat units of ethylene, from about 20 or 21 to about 30 wt % of copolymerized repeat units of a carboxylic acid monomer selected from acids in the group consisting of α,β-unsaturated acids having from 2 to 8 carbons, and from about 5 to about 1 20 wt % or from about 5 to about 15 wt % of copolymerized residues of alkyl esters of an α,β-unsaturated carboxylic acid having from 2 to 8 carbons, said alkyl groups containing from 1 to 4 carbons, wherein at least about 15 or 20% to about 35% of the carboxylic acid groups are neutralized, the counterions of the carboxylate groups are sodium or zinc cations, and the resin has a melt index of about 100 g/10 minutes or less, about 80 g/10 minutes or less, or about 60 g/10 minutes or less prior to neutralization.

Particularly preferred for use in the outer layers of a trilayer structure is an ionomer produced from an acid copolymer comprising about 78.3 wt % of copolymerized residues of ethylene and about 21.7 wt % of copolymerized residues of methacrylic acid. Also particularly preferred is an ionomer produced from an acid copolymer comprising about 68.3 wt % of copolymerized residues of ethylene, about 21.7 wt % of copolymerized residues of methacrylic acid, and about 10 wt % of copolymerized residues of n-butyl acrylate. The acid copolymer has a melt index of about 80 g/10 minutes or less prior to neutralization. In the particularly preferred ionomers, about 26% of the carboxylic acid groups are neutralized and sodium cations are the counterions of the carboxylate groups. Finally, suitable additives and additive levels for the ionomer composition are as described above with respect to the acid copolymer composition.

The thickness of the polymeric interlayer sheet is preferably about 0.3 to about 2.5 mm; more preferably about 0.5 to about 1.5 mm, and still more preferably about 0.7 to about 0.9 mm, whether in single layer or in multilayer form. When in multilayer form, the thickness of each sublayer is preferably about 0.1 mm to about 1.0 mm, and more preferably about 0.25 mm to about 1.0 mm. In some preferred trilayer structures, the thickness of the inner layer ranges from about 0.1 mm to about 0.6 mm, and the thickness of the outer layers ranges from about 0.1 to about 1.0 mm.

The polymeric interlayer sheets may be produced by any suitable process. For example, the sheets may be formed through dipcoating, solution casting, solution coating, compression molding, injection molding, lamination, melt extrusion, blown film, extrusion coating, tandem extrusion coating, coextrusion, calendering, blown film, blade, puddle, air-knife, printing, Dahlgren, gravure, powder coating, spraying or by any other procedures that are known to those of skill in the art. The parameters for each of these processes can be easily determined by one of ordinary skill in the art depending upon viscosity characteristics of the polymeric materials and the desired thickness of the layers of the laminate. In particular, the sheets may be formed by melt extrusion, melt coextrusion, melt extrusion coating, a blown film process, or a tandem melt extrusion coating process. Preferably, the multilayer polymeric sheets are produced through a coextrusion process or a lamination process.

The lamination process to produce the multilayer polymeric sheets generally involves forming a pre-press assembly, i.e., stacking preformed layers in the desired order, followed by lamination. Any suitable lamination process may be utilized, such as, for example, adhesive or tie layer lamination, solvent lamination, heat lamination and combinations of two or more of these techniques. Preferably, the preformed layers incorporate rough surfaces to facilitate desiring during lamination processes.

More preferably, the multilayer polymeric sheets are formed through a coextrusion process. Co-extrusion techniques provide a more efficient process by avoiding the formation of a pre-press assembly and through reduced vacuum requirements during the lamination process. Coextrusion is particularly preferred for formation of “endless” products, such as sheets, which emerge from the extruder as a continuous length. Briefly, each layer is generally provided from an individual extruder. Thus, each layer may have an individual composition. If two or more of the layers to be incorporated within the multilayer polymeric laminate are identical in composition, they may be fed from the same extruder or from individual extruders, as desired. For each individual composition, the polymeric material, whether provided as a molten polymer or as plastic pellets or granules, is fluidized and homogenized. Additives, as described above, may be added to the acid copolymer compositions in the dry blend or in the melt. Preferably, the melt processing temperature is from about 50° C. to about 300° C., more preferably, from about 100° C. to about 250° C. Recycled polymeric compositions may be used in place of or together with virgin polymeric compositions.

In general, the molten materials are conveyed to a coextrusion adapter that combines the molten materials to form a multilayer coextruded structure. The layered polymeric material is transferred through an extrusion die opened to a predetermined gap. Die openings may be within a wide range. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. Different kinds of die are used to produce different products, such as sheets and strips (slot dies) and hollow and solid sections (circular dies). Generally, a slot die, (T-shaped or “coat hanger” die), is utilized to produce multilayer sheets. The die may be as wide as 10 feet and typically have thick wall sections on the final lands to minimize deflection of the lips from internal pressure.

More specifically, the suitability of a multi-layer sheet construction for a particular end-use is dependent on several material factors, including sheet physical properties, polymer compatibility, and interlayer adhesion. In addition, the co-extrusion production of multi-layer sheeting is dependent on the properties of the constituent polymer materials, the sheet structure, and the nature of the co-extrusion equipment utilized. The potential range of operating conditions for each component as a mono-layer sheet may not be suitable for a multi-layer sheet, due to the influence of the additional polymer phases.

In co-extrusion, process equipment manipulates the polymer components into the desired position within the sheet structure. Typical equipment includes a feedblock and single manifold die, a multi-manifold die, or a hybrid combination die. Multiple polymer feed sources delivering uniform flow rate and temperature conditions are required. Extruders are typically used and can be either single or twin screw extruders. The extruders may feed directly to the feedblock/die assembly. Alternatively, they may feed a metering pump for more precise control of polymer feed rates and delivery pressures. Polymer flow streams may be single sourced, or the streams may be split with the polymer divided in the transfer line, feedblock, or die. The relative proportions of the stream divisions may be manipulated using adjustable flow splitters, such as vanes, within the feedblock or die assembly.

The desired sheet structure, including the overall sheet thickness as well as the number and thickness of the component polymer layers within the sheet, are material to the processing conditions. Positions of the polymer-polymer interfaces with the sheet are dictated by the overall and component material balances. The positions of these dynamic polymer-polymer interfaces within the sheeting determine the shear conditions at that interface. To produce optical quality multi-layer sheeting, stable polymer-polymer interfaces are necessary, requiring compatible rheological properties and flow characteristics are each interface. Failure to achieve compatibility at an interface will be characterized by sheeting optical distortions within the sheeting, which may include mottle, “orange peel” or “wood grain” effects. Additionally, a mismatch in the rheology of the sheet components will result in encapsulation effects at the sheet edges (extrusion die ends) with the low viscosity phase moving to encapsulate the high viscosity layer(s).

The rheological properties of each component sheet layer are both polymer dependent and a function of flow conditions, including shear rate and temperature. While the temperature conditions for each polymer phase can be independently controlled at the extruder, the ability to maintain individual phase control within the feedblock/die assembly is production equipment dependent. Once the component polymer phases have been manipulated into the final sheet structure, only a single (die) temperature can be specified or maintained. Rapid heat transfer processes across the sheet structure will occur, and the sheet thermal conditions will move toward equilibrium. The rapid heat transfer within the die usually precludes co-extrusion conditions with large disparities in layer temperatures.

Finally, the polymeric interlayer sheet may have a smooth or rough surface on one or both sides to facilitate deaeration during the lamination process. Rough surfaces can be created by known processes such as mechanical embossing or by melt fracture during extrusion of the sheets, or by processes described in U.S. Pat. No. 4,035,549 and U.S. Patent Publication No. 2003/0124296, for example.

Further provided is a safety laminate comprising at least one rigid sheet layer or at least one film layer and at least one polymeric interlayer sheet that comprises the acid copolymer composition. One preferred safety laminate comprises at least one interlayer sheet comprising the ionomer composition, and the interlayer sheet is laminated to at least one rigid sheet or film layer.

Suitable rigid sheets comprise a material with a modulus of about 100,000 psi (690 MPa) or greater (as measured by ASTM Method D-638). The rigid sheets used here may be formed of glass, metal, ceramic, or of polymers including polycarbonates, acrylics, polyacrylates, cyclic polyolefins, such as ethylene norbornene copolymers, polystyrene prepared in the presence of metallocene catalysts, and combinations of two or more thereof. Other suitable rigid sheets are described in U.S. Pat. No. 8,399,098, issued to Bennison et al.

Preferably, the rigid sheet is glass. The term “glass” includes not only window glass, plate glass, silicate glass, sheet glass, and float glass, but also includes colored glass, specialty glass which includes ingredients to control solar heating, glass coated with sputtered metals such as silver or indium tin oxide for solar control purposes, E-glass, Toroglass and Solex® glass. Such specialty glasses are described in U.S. Pat. Nos. 4,615,989; 5,173,212; 5,264,286; 6,150,028; 6,340,646; 6,461,736; and 6,468,934, for example. The type of glass to be selected for a particular laminate depends on the desired properties for the laminate's intended use.

The film layers used herein may be metallic (such as aluminum foil) or polymeric. Suitable polymeric film materials include, but are not limited to, those described in U.S. Pat. No. 8,399,098, cited above. Preferred films for use as polymeric film layers are oriented and unoriented polyester films, polycarbonate films, polyurethane films and polyvinyl chloride films. Most preferably, an additional film layer is biaxially oriented poly(ethylene terephthalate).

Bilayer and multilayer film structures may also be utilized as the polymeric film. One advantage to multilayer films is that specific properties can be tailored into the film to solve critical use needs while allowing the more costly ingredients to be relegated to the outer layers where they provide the greater needs. The additional layers may serve as barrier layers, adhesive layers, antiblocking layers, or for other purposes.

When the polymeric film is located at the outside surface of the safety laminate, it may be further coated with an abrasion resistant hardcoat. Any material known for use in abrasion resistant hardcoats may be used herein. Suitable materials include, but are not limited to, those described in U.S. Pat. No. 8,399,098, cited above.

Finally in this connection, the difference between a film and a sheet is the thickness, but there is no set industry standard as to when a film becomes a sheet. As used herein, the term “film” refers to a structure having a thickness of about 10 mils (0.25 mm) or less, and the term “sheet” refers to a structure having a thickness of greater than about 10 mils (0.25 mm). When specifically indicated in certain embodiments, however, the term “film” refers to a structure having a thickness of about 5 mils (0.13 mm) or less, and the term “sheet” refers to a structure having a thickness of greater than about 5 mils (0.13 mm).

The safety laminates may further comprise other polymeric interlayer sheets formed of polymeric materials, such as poly(vinyl acetal) (e.g., poly(vinyl butyral) (PVB)), acoustic poly(vinyl acetal) (e.g., acoustic PVB), poly(vinyl chloride), polyurethanes, such as thermoplastic polyurethanes, ISD polyacrylate materials, ethylene/vinyl acetate copolymers, other acid copolymer resins, ionomers of other acid copolymer resins, or combinations of two or more thereof. In addition, when two or more polymeric sheets are incorporated in the safety laminate, the polymeric interlayer sheets may be formed of polymeric materials that are the same or different.

Each of the interlayer sheets comprising the acid copolymer compositions and each of the other polymeric interlayer sheets comprised in the safety laminates may have a thickness of at least about 5 mils (0.13 mm) or at least about 10 mils (0.25 mm), or at least about 30 mils (0.8 mm), or about 30 to about 200 mils (about 0.8 to about 5.1 mm), or about 45 to about 200 mils (about 1.1 to about 5.1 mm), or about 45 to about 100 mils (about 1.1 to about 2.5 mm), or about 45 to about 90 mils (about 1.1 to about 2.3 mm).

One preferred safety laminate comprises (a) a first rigid sheet or film layer, which is laminated to (b) a sheet comprising the acid copolymer composition, which is laminated to (c) a second rigid sheet or film layer. For example, the safety laminate may comprise two glass sheets with an interlayer sheet comprising the acid copolymer composition laminated between the two glass sheets, or the safety laminate may comprise a glass sheet and a hardcoated polyester film with an interlayer sheet comprising the acid copolymer composition laminated between the glass sheet and the hardcoated plastic film.

Another safety laminate may comprise n plies of rigid sheet or film layers (such as glass sheet layers) and n−1 plies of polymer interlayer sheets, wherein (a) each adjacent pair of the rigid sheet or film layers are interspaced by one of the polymer interlayer sheets; (b) at least one, or preferably each, of the polymer interlayer sheets is the polymeric interlayer sheet described above, and (c) n is an integer and 2≦n≦10. Such safety laminates are described at length in U.S. Pat. No. 7,641,965, cited above.

Some examples of preferred safety laminates include, but are not limited to, rigid sheet/interlayer sheet; polymer film/interlayer sheet; rigid sheet/interlayer sheet/polymer film; rigid sheet/interlayer sheet/rigid sheet; polymeric film/interlayer sheet/polymer film; rigid sheet/interlayer sheet/polymer film/interlayer sheet/rigid sheet; and others set forth in U.S. Pat. No. 8,399,098, cited above, wherein “/” indicates adjacent layers. Moreover, when two or more of any film or sheet occur in the same laminate, they may be the same as or different from each other, provided that at least one of the interlayer sheets comprises or is produced from the ionomer composition described herein. Furthermore, in some preferred laminates, the adjacent layers are laminated directly to each other so that they are adjoining or, more preferably, contiguous in the laminate structure.

In certain applications, the laminate is required to dampen sound, but it is not required to be optically transparent. Also, the laminate may not be required to function as a safety laminate; in particular, there may not be a need for a high level of adhesion between the polymeric interlayer sheet and the adjacent layers, such as the rigid sheets, for example. In addition, the polymeric interlayer sheet may not be required to have a high level of stiffness or penetration resistance. Examples include, without limitation, laminates for façades, exterior walls and roofs; panels, doors, walls and other interior partitions; architectural structures and transportation vehicles. Transportation vehicles include, without limitation, automobiles, busses, trucks, boats, trains and airplanes. Laminates designed for these end uses may include rigid sheets made from opaque or translucent materials such as metal, ceramic, stone, pigmented polymers or pigmented glass. In addition or in the alternative, these laminates may also include opaque or translucent interlayers. In other respects the structures are similar to those described above for safety laminates. It may be preferable in these applications, however, to use thicker layers and to incorporate a higher level of filler into the polymeric interlayer sheets. Examples of suitable acid copolymer compositions for these end uses are described in U.S. Pat. No. 4,191,798, issued to Schumacher et al., for example.

If desired, one or both surfaces of any of the component layers comprised in the safety laminate may be treated prior to the lamination process to enhance the adhesion to other laminate layers. This adhesion enhancing treatment may take any form known within the art and includes, without limitation, flame treatments (see, e.g., U.S. Pat. Nos. 2,632,921; 2,648,097; 2,683,894; and 2,704,382), plasma treatments (see, e.g., U.S. Pat. No. 4,732,814), electron beam treatments, oxidation treatments, corona discharge treatments, chemical treatments, chromic acid treatments, hot air treatments, ozone treatments, ultraviolet light treatments, sand blast treatments, solvent treatments, and combinations of two or more thereof. Also, the adhesion strength may be further improved by further applying an adhesive or primer coating on the surface of the laminate layer(s). For example, U.S. Pat. No. 4,865,711 discloses a film or sheet with improved bondability, which has a thin layer of carbon deposited on one or both surfaces. Other examples of suitable adhesives or primers include, without limitation, silanes, poly(allyl amine) based primers (see, e.g., U.S. Pat. Nos. 5,411,845; 5,770,312; 5,690,994; and 5,698,329), and acrylic based primers (see, e.g., U.S. Pat. No. 5,415,942). The adhesive or primer coating may take the form of a monolayer of the adhesive or primer and may have a thickness of about 0.0004 to about 1 mil (about 0.00001 to about 0.03 mm), or preferably, about 0.004 to about 0.5 mil (about 0.0001 to about 0.013 mm), or more preferably, about 0.004 to about 0.1 mil (about 0.0001 to about 0.003 mm).

Finally, any suitable lamination process, including autoclave and non-autoclave processes, may be used to prepare the safety laminates. For example, the laminate may be made by an autoclave process, such as those described in U.S. Pat. No. 3,311,517, or a non-autoclave lamination process, such as those described in U.S. Pat. Nos. 3,234,062; 3,852,136; 4,341,576; 4,385,951; 4,398,979; 5,536,347; 5,853,516; 6,342,116; and 5,415,909; U.S. Patent Application Publication No. 2004/0182493; European Patent No. EP 1 235 683 B1; and International Patent Application Publication Nos. WO91/01880 and WO03057478.

The following examples are provided to describe the invention in further detail. These examples, which set forth a preferred mode presently contemplated for carrying out the invention, are intended to illustrate and not to limit the invention.

### Examples

### A. Materials

The glass used in the Examples was obtained from Technical Glass Products, Inc., of Ivyland, Pa. The standard PVB polymers used in the Examples were obtained from E.I. du Pont de Nemours & Company (“DuPont”) of Wilmington, Del., under the Butacite® trademark. Acid copolymer resins and their ionomers were obtained from DuPont under the trademarks Nucrel®, Surlyn® or SentryGlas®. Alternatively, the polymers were synthesized by the methods described in U.S. Pat. No. 8,399,096. As described above, a sufficiently high level and complementary amount of the derivative of the second α,β-ethylenically unsaturated carboxylic acid was present in the reaction mixture. The compositions of the interlayers in Examples E6, E7, E8 and E9 were determined by NMR spectroscopy, and the compositions of the ethylene acid copolymers and ionomers in the remainder of the interlayers were determined by mass balance methods.

### B. Methods

### 1. Standard Lamination Procedure

A pre-press assembly, in which the layers in the laminate are stacked in the desired order, was placed into a vacuum bag and held at reduced pressure for 30 minutes to remove any air contained between the layers of the pre-press assembly. The pre-press assembly was heated at 135° C. for 60 minutes in an air autoclave at a pressure of 100 to 200 psig (14.3 bar). The air was then cooled without adding additional gas, so that the pressure in the autoclave was allowed to decrease. After 20 minutes of cooling, when the air temperature was less than about 50° C., the excess pressure was vented, and the laminate was removed from the autoclave.

### 2. Melt Index

Melt indices (MI) were measured according to ASTM method D1238 at a polymer melt temperature of 190° C. and under a weight of 2.16 kg.

### 3. Acoustic Measurements

Acoustic measurements were made in accordance with ISO Standard No. 16940 (2008). Briefly, a beam of laminated glass measuring 300 mm×25 mm was excited at random frequencies between 0 Hz and 10 kHz. The impedance (Z=force/velocity) was measured at the center of the beam. The resonances at the first three or four modes were examined, and the bending rigidity (stiffness) and loss factor (damping) were derived at each mode from its characteristic frequency and broadening. In addition, the theoretical sound transmission loss, TL or R, was calculated from the beam properties at the third mode using Cremer's equation.

### 4. Dynamic Mechanical Analysis

Dynamic mechanical properties of the polymer interlayers were determined following ASTM D4065-06 using a mechanical spectrometer (Mettler model DMA/SDTA861e). Polymers were tested in a shear oscillation mode operating at a fixed sinusoidal frequency of 1,000 Hz (1 kHz) with a maximum amplitude of 0.1% shear strain. Test samples, which were cut from compression molded polymer sheets, had a cylindrical shape with a diameter in the range of 3 to 5 mm and with a thickness in the range of 0.5 to 1.5 mm. Tests were carried out for a temperature range of −20° C. to 60° C. while ramping the temperature at a rate of 1° C./minute. The polymer storage shear modulus (G′) and loss shear modulus (G″) were determined directly from this test. Tan Delta (“tan δ”), which is a measure of the polymer damping, and the complex shear modulus, G*, which is a measure of the polymer shear stiffness, were derived from G′ and G″ as defined in ASTM D4092-07. The values of the complex shear modulus, G*, and tan δ at 1 kHz and 20° C. are reported in Tables 1 and 2. Since the 1 to 5 kHz frequency range is an important region for sound transmission to the human ear, tan δ and shear modulus behavior measured at 1 kHz and 20° C. can be used as an indicator of the acoustic performance capability of the polymer. Higher tan δ values and lower shear modulus values are desirable for improved acoustic performance.

### C. Examples and Comparative Examples

Three sets of glass laminates were laid up and laminated according to the standard procedure. The glass layers in the laminates had a thickness of 1.6 mm, and the interlayers had a thickness of 0.76 mm. The initial dimensions of the laminates were 203 mm×305 mm; before testing, they were cut by water-jet into beams measuring 25 mm×300 mm, except that Examples E12 and T1 through T4 were made directly to size as 150 mm by 20 mm beams. The polymeric interlayers in each laminate and the laminates' acoustic properties are set forth in the Tables, below.

In Table 2, CE7 is a replication of CE1; CE8 is a replication of CE2; CE9 is a replication of CE3; and CE10 is a replication of CE4.

In Table 3, the interlayer sheets have a trilayer structure. The trilayer sheets were produced by co-extrusion. In addition, these laminates have the structure “Glass 1/trilayer sheet/Glass 2”.

The data in Tables 1 and 2 demonstrate that acid copolymer compositions described herein, such as Examples E5 and E9, provide laminates that have acoustic properties superior to those of PVB laminates, such as Comparative Examples CE2 and CE8. In addition, the laminates of the acid copolymer compositions described herein maintain a sufficient stiffness at a conventional thickness, so that they may be used as noise-reducing safety laminates in automobile sidelights, for example. The data in Table 3 demonstrate that the superior acoustic properties are also available in laminates of multilayer sheets, in which one of the sub-layers comprises the acid copolymer composition described herein.

While certain of the preferred embodiments of this invention have been described and specifically exemplified above, it is not intended that the invention be limited to such embodiments. Various modifications may be made without departing from the scope and spirit of the invention, as set forth in the following claims.

TABLE 1

| | | | | | | | Shear | | Bending | | |
|---|---|---|---|---|---|---|---|---|---|---|---|
| | | | | | | | Modulus, | Third | Stiffness- | Loss | Transmission |
| | | | | | | | G* | Mode | 3rd | Factor- | Loss at |
| Example | Interlayer | Acrylate | Acid | Ion/ | | Tan Delta | (1 kHz/20 C.) | Frequency | Mode | 3rd | 5000 Hz |
| No. | Composition | (w %) | (w %) | Neutralization | MI | (1 kHz/20 C.) | MPa | (Hz) | (N · m) | Mode | (dB) |
| CE1 | None—monolithic | NA* | NA | NA | NA | Not | Not | 2720 | 384 | 0.006 | 28.8 |
| | glass | | | | | Measured | Measured | | | | |
| CE2 | PVB | NA | NA | NA | NA | 0.24 | 189 | 2272 | 248 | 0.123 | 32.7 |
| CE3 | E/MAA | None | 21.7 | Na⁺/26% | 1.8 | 0.057 | 205 | 2552 | 310 | 0.035 | 32.1 |
| CE4 | E/nBA/MAA | 10 | 21.7 | Na⁺/26% | 6 | 0.079 | 244 | 2504 | 296 | 0.038 | 31.8 |
| CE5 | E/nBA/MAA—Na | 21 | 9 | Na⁺/52% | 1 | 0.25 | 44 | 1736 | 144 | 0.129 | 36.3 |
| CE6 | E/nBA/MAA—Zn | 21 | 9 | Zn²⁺/51% | 0.75 | 0.28 | 46 | 1688 | 136 | 0.142 | 37.2 |
| E1 | E/nBA/MAA | 25 | 12 | None | 50 | 0.62 | 12 | 1248 | 73.3 | 0.186 | 42.1 |
| E2 | E/nBA/MAA—Na | 25 | 20 | Na⁺/12% | 56 | 0.60 | 59 | 1696 | 134 | 0.33 | 38.1 |
| E3 | E/nBA/MAA—Na | 25 | 20 | Na⁺/19% | 26 | 0.46 | 88 | 1872 | 166 | 0.222 | 34.8 |
| E4 | E/nBA/MAA—Na | 25 | 17 | Na⁺/16% | 29 | 0.57 | 56 | 1680 | 132 | 0.267 | 37.9 |
| E5 | E/nBA/MAA—Na | 25 | 15 | Na⁺/15% | 30 | 0.54 | 57 | 1808 | 154 | 0.239 | 36 |

*Note:
“NA” means “not applicable.”

TABLE 2

| | | | | | | | | | Bending | | Sound |
|---|---|---|---|---|---|---|---|---|---|---|---|
| | | | | | | | Shear | Third | Stiffness- | Loss | Transmission |
| | | | | | | | Modulus, | Mode | 3rd | Factor- | Loss at |
| Example | Interlayer | Acrylate | Acid | Ion/ | | Tan Delta | G′ [MPa] | Frequency | Mode | 3rd | 3,150 Hz |
| Number | Composition | (wt %) | (wt %) | Neutralization | MI | (1 kHz/20 C.) | (1 kHz/20 C.) | [Hz] | [N · m] | Mode | [dB] |
| CE7 | None—Monolithic | NA* | NA | NA | NA | NA | NA | 3296 | 669 | 0.007 | 14.9 |
| | Glass (5 mm) | | | | | | | | | | |
| CE8 | PVB | NA | NA | NA | NA | 0.24 | 189 | 2848 | 518 | 0.104 | 33.3 |
| CE9 | E/MAA—Na | None | 21.7 | Na⁺/26% | 1.8 | 0.023 | 222 | 3168 | 659 | 0.018 | 20.9 |
| CE10 | E/nBA/MAA—Na | 10 | 21.7 | Na⁺/26% | 6 | 0.079 | 244 | 3040 | 589 | 0.063 | 28.7 |
| E6* | E/nBA/MAA | 19 | 14 | None | 60 | 0.718 | 16.2 | 1824 | 218 | 0.219 | 41.6 |
| E7* | E/nBA/MAA | 19 | 15 | None | 60 | 0.783 | 20 | 1904 | 236 | 0.252 | 41.3 |
| E8* | E/nBA/MAA | 23 | 17 | None | 60 | 0.93 | 12.4 | 1664 | 183 | 0.183 | 42.3 |
| E9* | E/nBA/MAA | 21 | 14 | None | 60 | 0.72 | 13.6 | 1680 | 192 | 0.191 | 42.4 |
| E10 | E/nBA/MAA | 18 | 17 | None | 47 | 0.659 | 37.8 | 2112 | 287 | 0.261 | 40.2 |
| E11 | E/nBA/MAA | 20 | 17 | None | 57 | 0.836 | 21.6 | 2000 | 256 | 0.284 | 40.7 |
| E12 | E/nBA/MAA—Zn | 20 | 17 | Zn²⁺/2.5% | 36 | 0.847 | 21 | 6660 | 200 | 0.17 | 38.8 |

*Notes:
“NA” means “not applicable;” compositions of the interlayers in the indicated Examples were determined by NMR.

TABLE 3

| | | | | Nominal | | Polymer | | | Sound |
|---|---|---|---|---|---|---|---|---|---|
| | | | | Trilayer | | Trilayer | | Total | Transmission |
| | Polymer | Polymer | Polymer | Polymer | Glass 1 | Total | Glass 2 | Laminate | Loss at |
| Example | Layer | Layer | Layer | Structure | Thickness | Thickness | Thickness | Thickness | 3150 Hz |
| Number | 1* | 2* | 3* | Ratio | (mm) | (mm) | (mm) | (mm) | (dB) |
| T1 | A | B | A | 1\|3\|1 | 2.3 | 0.76 | 2.3 | 5.36 | 36.7 |
| T2 | A | B | A | 1\|8\|1 | 2.3 | 0.76 | 2.3 | 5.36 | 38.2 |
| T3 | A | C | A | 2\|5\|2 | 2.3 | 0.76 | 2.3 | 5.36 | 39.8 |
| T4 | D | B | D | 1\|3\|1 | 2.3 | 0.76 | 2.3 | 5.36 | 40.6 |

*Notes:
A = copolymer of interlayer in Comparative Example CE10;
B = ionomer of interlayer in Example E12;
C = copolymer of interlayer in Example E1;
D = copolymer of ethylene and vinyl acetate (“EVA”; 33 wt % vinyl acetate; melt index = 1 g/10 min).

What is claimed is:

1. A polymeric interlayer sheet comprising an acid copolymer composition, said acid copolymer composition comprising an acid copolymer resin or an ionomer that is the neutralized product of the acid copolymer resin;
wherein the acid copolymer resin comprises copolymerized units of an α-olefin having 2 to 10 carbon atoms; about 10 to about 25 wt % of copolymerized units of a first α,β-ethylenically unsaturated carboxylic acid having 3 to 10 carbon atoms; and about 15 to about 30 wt % of copolymerized units of a derivative of a second α,β-ethylenically unsaturated carboxylic acid having 3 to 10 carbon atoms;
wherein the acid copolymer resin has a melt flow rate of about 1 to about 400 g/10 min, as determined in accordance with ASTM D1238 at 190° C. and 2.16 kg;
wherein the sum of the weight percentages of the copolymerized units in the acid copolymer resin is 100 wt % and the weight percentages are based on the total weight of the acid copolymer resin; and
wherein the first and the second α,β-ethylenically unsaturated carboxylic acids may be the same or different.

2. The polymeric interlayer sheet of claim 1, wherein the acid copolymer composition has a tan δ greater than 0.25, when measured according to ASTM D4065 at 20° C. and 1 kHz.

3. The polymeric interlayer sheet of claim 1, wherein the acid copolymer composition has a shear modulus less than 150 MPa, when measured according to ASTM D4065 at 20° C. and 1 kHz.

4. The polymeric interlayer sheet of claim 1, wherein the acid copolymer composition comprises the ionomer, and wherein up to about 50% of the carboxylic acid groups in the acid copolymer resin are neutralized to form the ionomer.

5. The polymeric interlayer sheet of claim 4, wherein the counterion comprises a sodium cation or a zinc cation.

6. The polymeric interlayer sheet of claim 1, wherein the melt index of the acid copolymer resin is 10 to 100 g/10 min.

7. The polymeric interlayer sheet of claim 1, wherein the first α,β-ethylenically unsaturated carboxylic acid comprises methacrylic acid.

8. The polymeric interlayer sheet of claim 1, wherein the derivative of the second α,β-ethylenically unsaturated carboxylic acid is a butyl acrylate.

9. The polymeric interlayer sheet of claim 1, wherein the acid copolymer resin comprises about 15 to about 30 wt % of copolymerized units of the derivative of the second α,β-ethylenically unsaturated carboxylic acid.

10. The polymeric interlayer sheet of claim 1, wherein the acid copolymer composition comprises up to 50 wt % of pigment or filler.

11. A safety laminate comprising the polymeric interlayer sheet of claim 1 and a rigid sheet or a polymeric film.

12. The safety laminate of claim 11, wherein the rigid sheet comprises a material having a modulus of about 690 MPa or greater, as determined in accordance with ASTM D638, and wherein the material is selected from the group consisting of glass, metal, ceramic, and polymers.

13. The safety laminate of claim 12, wherein the film layer is a metal film or a polymeric film comprising one or more materials selected from the group consisting of polyesters, polycarbonates, polyolefins, norbornene polymers, polystyrenes, styrene-acrylate copolymers, acrylonitrile-styrene copolymers, polysulfones, polyamides, polyurethanes, acrylic polymers, cellulose acetates, cellophanes, vinyl chloride polymers and fluoropolymers.

14. The safety laminate of claim 11, further comprising one or more other polymeric interlayer sheets, wherein the one or more other polymeric interlayer sheets comprise one or more materials selected from the group consisting of poly(vinyl acetals), poly(vinyl chlorides), polyurethanes, ethylene/vinyl acetate copolymers, acid copolymers, and ionomers.

15. The safety laminate of claim 11, wherein the at least one interlayer sheet comprising the ionomer composition is laminated between two glass sheets.

16. The safety laminate of claim 11, wherein the at least one interlayer sheet comprising the ionomer composition is laminated between a glass sheet and a polyester film that is coated with an abrasion resistant hardcoat on the surface that is facing away from the interlayer sheet.

17. The polymeric interlayer sheet of claim 1 that is in multilayer form, said polymeric interlayer sheet comprising at least one additional sublayer, wherein the additional sublayers are the same or different and wherein the additional sublayer(s) comprise one or more materials selected from the group consisting of an additional acid copolymer resin, an additional ionomer that is the neutralized product of the additional acid copolymer resin, an ethylene/vinyl acetate copolymer, a poly(vinyl acetal), a polyurethane, a polyvinylchloride, a polyethylene, a polyolefin block elastomer, a copolymer of an α-olefin and one or more esters of α,β-ethylenically unsaturated carboxylic acids, a silicone elastomer and an epoxy resin.

18. The polymeric interlayer sheet of claim 17, wherein at least one of the additional sublayer(s) comprises a second acid copolymer or an ionomer of the second acid copolymer.

19. The polymeric interlayer sheet of claim 18, comprising two additional sublayers and having the structure “first sublayer/second sublayer/third sublayer”, wherein the second sublayer comprises the acid copolymer composition and the first and third sublayers comprise the ionomer of the second acid copolymer.

20. The polymeric interlayer sheet of claim 19, wherein the second acid copolymer comprises copolymerized residues of a second α-olefin; about 0.1 to about 30 weight percent of a second α,β-ethylenically unsaturated carboxylic acid comonomer; and from 0 to about 50 wt % of copolymerized repeat units of one or more second additional comonomers; and wherein the melt flow rate of the second acid copolymer is less than about 200 g/10 min, and the melt flow rate of the ionomer of the second acid copolymer is from about 1 to about 50 g/10 min.

21. The polymeric interlayer sheet of claim 20, wherein the second α-olefin is ethylene; the second α,β-unsaturated carboxylic acids are selected from the group consisting of acrylic acid and methacrylic acid; the second additional comonomer(s) are selected from the group consisting of glycidyl methacrylate, vinyl acetate, and alkyl esters of acrylic acid or methacrylic acid, said alkyl groups containing from 1 to 4 carbon atoms; and the ionomer of the second acid copolymer comprises cations selected from the group consisting of cations of alkali metals and alkaline earth metals.

22. The polymeric interlayer sheet of claim 21, wherein the second acid copolymer comprises about 55 to about 75 wt % of copolymerized residues of ethylene and from about 20 to about 30 wt % of copolymerized residues of acrylic acid or methacrylic acid; and about 5 to 15 wt % of copolymerized residues of an alkyl ester of acrylic acid or methacrylic acid, wherein the second acid copolymer has a melt index of about 80 g/10 min or less; and wherein the ionomer of the second acid copolymer comprises about 15% to about 35% of carboxylate groups, based on the total number of carboxylic acid groups in the second acid copolymer, and wherein the counterions of the carboxylate groups comprise sodium cations.

23. The polymeric interlayer sheet of claim 17, comprising two additional sublayers and having the structure “first sublayer/second sublayer/third sublayer”, wherein the second sublayer comprises the acid copolymer composition and the first and third sublayers comprise a copolymer of ethylene and vinyl acetate.

24. A safety laminate comprising the polymeric interlayer sheet of claim 17.

25. The safety laminate of claim 19, wherein the first or the third sublayer comprises one or more silane coupling agents selected from the group consisting of dialkoxysilanes and γ-chloropropylmethoxysilane, vinyltrimethoxy-silane, vinyltriethoxysilane, vinyltris(β-methoxyethoxy) silane, γ-vinylbenzyl-propyltrimethoxysilane, N-β-(N-vinylbenzylaminoethyl)-γ-aminopropyl-trimethoxy-silane, γ-methacryloxypropyl-trimethoxysilane, vinyltriacetoxy-silane, γ-glycidoxypropyl-trimethoxy-silane, γ-glycidoxypropyl-triethoxysilane, β-(3,4-epoxycyclohexyl)-ethyltrimethoxysilane, vinyltrichlorosilane, γ-mercaptopropylmethoxysilane, γ-aminopropyltriethoxysilane, and N-β-(aminoethyl)-γ-aminopropyltrimethoxysilane; and
wherein the first or the third sublayer optionally further comprises one or more additives selected from the group consisting of thermal stabilizers, UV absorbers, and hindered amine light stabilizers.
